(19) United States
(12) Patent Application Publication
(10) Pub. No.: US 2026/0235196 A1
(43) Pub. Date: Aug. 13, 2026

(54) ELECTRONIC TORQUE VECTORING SYSTEM

(71) Applicant: LINAMAR CORPORATION, Guelph (CA)

(72) Inventor: Rohit Abraham, Wake Forest, NC (US)

(21) Appl. No.: 19/157,599

(22) PCT Filed: Feb. 19, 2024
(86) PCT No.: PCT/US2024/016340

§ 371 Date: Aug. 18, 2025

Related U.S. Application Data
(60) Provisional application No. 63/447,790, filed on Feb. 23, 2023.

(51) Int. Cl. F16H 48/36

(52) U.S. Cl. CPC F16H 48/36; F16H 2048/364

(57) ABSTRACT

A torque vectoring device for a vehicle drive module. The torque vectoring device includes an electric actuator and a planetary gearset. The planetary gearset includes a ring gear, a sun gear, a planet carrier, and at least one planet gear. The ring gear is rotationally coupled to a differential case of a vehicle drive module. The sun gear is operatively couplable to the electric actuator. The planet carrier is rotationally coupled to a first output shaft of the drive module. The at least one planet gear is rotationally supported by the planet carrier and engaged with the ring gear and the sun gear. The electric actuator is operable to bias torque between the first output shaft and the second output shaft of the drive module.

### CROSS-REFERENCE TO RELATED APPLICATIONS

The subject patent application claims priority to, and all the benefits of, U.S. Provisional Patent Application No. 63/447,790, filed on Feb. 23, 2023, the entire contents of which are incorporated by reference herein.

### BACKGROUND

Vehicle drive systems typically include a differential, which facilitates unequal rotation rates between the vehicle's wheels as the vehicle navigates a turn. Performance characteristics of the vehicle can be enhanced by improving the vehicle dynamics, such as how quickly the vehicle can maneuver through a turn. Increasing the yaw rate of the vehicle, i.e., how quickly the vehicle can turn without losing traction may improve the vehicle dynamics. Torque vectoring facilitates managing how much torque is sent to each wheel, which is something that cannot be achieved with an open differential

Typically, torque vectoring systems operate with a series of multiple planetary gearsets and a series of hydraulically actuated brakes to bias torque between the wheels of the vehicle. Hydraulic systems for operating the torque vectoring device require various solenoids and valves, each of which presents a potential failure point of the torque vectoring system. A torque vectoring system that overcomes these disadvantages is desired.

### SUMMARY

In one aspect, a torque vectoring device for a vehicle drive module is provided. The torque vectoring device comprises an electric actuator and a planetary gearset. The planetary gearset comprises a ring gear, a sun gear, a planet carrier, and at least one planet gear. The ring gear is rotationally coupled to a differential case of a vehicle drive module. The sun gear is operatively couplable to the electric actuator. The planet carrier is rotationally coupled to a first output shaft of the drive module. The planet gear is rotationally supported by the planet carrier and engaged with the ring gear and the sun gear. The electric actuator is operable to bias torque between the first output shaft and the second output shaft of the drive module. In one implementation, the torque vectoring device may further comprise a disconnect synchronizer rotationally coupled to the sun gear and the electric actuator. The disconnect synchronizer may be operable in a locked mode for transferring torque between the electric actuator and the sun gear and an unlocked mode in which torque is not transferred between the electric actuator and the sun gear.

In another aspect, a drive module for a vehicle is provided. The drive module comprises a first output shaft, a second output shaft, a differential assembly, and a torque vectoring device. The torque vectoring device comprises an electric actuator, a ring gear, a sun gear, a planet carrier, and a planet gear. The ring gear is rotationally coupled to the differential assembly. The sun gear is operatively couplable to the electric actuator. The planet carrier is rotationally coupled to the first output shaft. The planet gear is rotationally supported by the planet carrier and engaged with the ring gear and the sun gear. The electric actuator is operable to bias torque between the first output shaft and the second output shaft. In one implementation, the torque vectoring device may further comprise a disconnect synchronizer rotationally coupled to the sun gear and the electric actuator. The disconnect synchronizer may be operable in a locked mode for transferring torque between the electric actuator and the sun gear and an unlocked mode in which torque is not transferred between the electric actuator and the sun gear.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawing.

FIG. 1 is a schematic representation of one embodiment of a drive module for a vehicle showing an electronic torque vectoring device.

Certain terminology will be used in the following description for convenience and reference only and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. The terminology will include the words specifically mentioned, derivatives thereof, and words of similar import.

### DETAILED DESCRIPTION

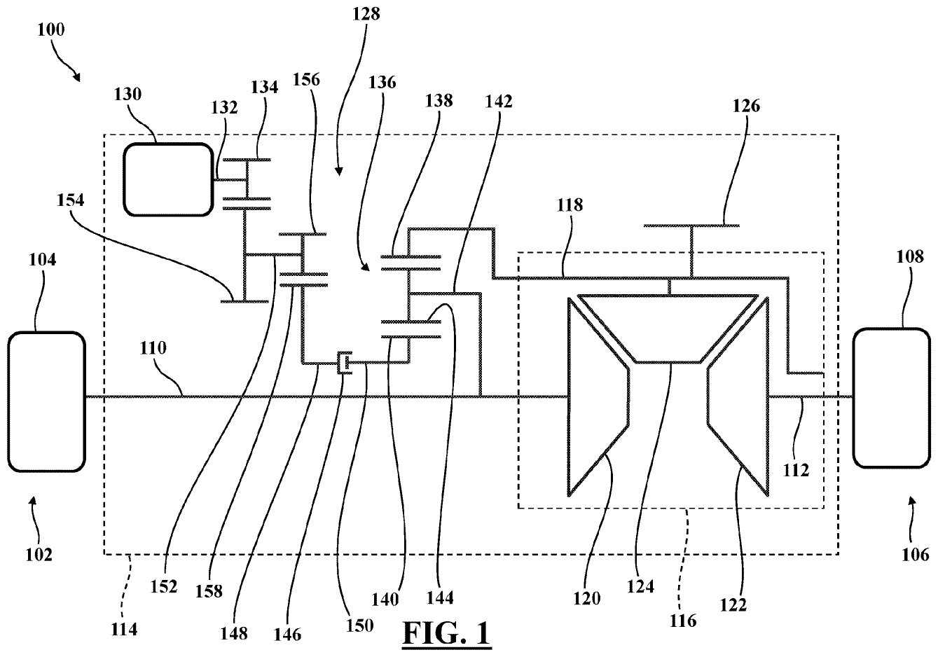

Referring to FIG. 1, a schematic representation of a drive module 100 for a vehicle (not shown) is illustrated. An exemplary implementation of the vehicle is a passenger car, which may include a front drive module and/or a rear drive module. In this way, the drive module 100 may be further defined as a front drive module arranged at the front of the vehicle or a rear drive module arranged at the rear of the vehicle. The drive module 100 comprises a first output 102 driving a first wheel 104 and a second output 106 driving a second wheel 108. Here, the first output 102 and the first wheel 104 are illustrated on the left of FIG. 1 and may be interchangeably referred to as a left output 102 and a left wheel 104 for the sake of clarity. Similarly, the second output 106 and the second wheel 108 are arranged on the right are illustrated on the right of FIG. 1 and may be interchangeably referred to as a right output 106 and a right wheel 108 for the sake of clarity. It should be appreciated that the words “left” and “right” as used herein are merely a reference to the exemplary schematic illustrated in FIG. 1 and not a particular arrangement in the vehicle. More specifically, the left output 102 may ultimately drive a wheel arranged on the left side or the right side of the vehicle and the right output 106 may ultimately drive a wheel arranged on the right side or the left side of the vehicle.

The first output 102 and the second output 106 of the drive module 100 may further comprise a first output shaft 110 and a second output shaft 112. Herein the first output shaft 110 is a left output shaft 110 and the second output shaft 112 is a right output shaft 112. As will be discussed in further detail below, the first and second output shafts 110, 112 are ultimately coupled to the wheels 104, 108 to supply motive power to the vehicle. The left output 102 and the right output 106 may be implemented in various forms without departing from the scope of the present disclosure in order to suit the type of vehicle in which the drive module 100 is utilized. In one exemplary implementation, the drive module 100 may be a rear drive module installed in a vehicle with an independent rear suspension. In this implementation, the first and second output shafts 110, 112 may be implemented as half-shafts that are coupled to the corresponding first and second wheels 104, 108. In another implementation, the first and second outputs 102, 106 may be implemented as stub shafts having a flange (not shown) configured to be coupled to a constant-velocity joint of a half-shaft (not shown). In yet another implementation, the vehicle may be a pickup truck and the drive module 100 may be integrated into a solid axle assembly. In this implementation, the first and second output shafts 110, 112 may be implemented as solid axle shafts that are supported in axle tubes and coupled directly to the corresponding first and second wheels 104, 108.

The drive module 100 may further comprise a drive housing 114 configured to be coupled to the vehicle. In order to transfer motive power to the first and second wheels 104, 108, the drive module 100 may further comprise a differential assembly 116, which allows the first and second wheels 104, 108 to rotate at different speeds as the vehicle is turning. The differential assembly 116 illustrated herein may be a bevel gear differential and may comprise a differential case 118 rotatably supported in the drive housing 114, a left side gear 120 operatively coupled to the left output shaft 110, a right side gear 122 operatively coupled to the right output shaft 112, and at least one spider gear 124 engaged with the left and right side gears 120, 122. The left and right side gears 120, 122 and the spider gear 124 are arranged in the differential case 118. The differential assembly 116 may further comprise an input gear 126 coupled to the differential case 118 and configured to be rotated by a motor or engine (not shown) of the vehicle. In one implementation, the input gear 126 may be a hypoid ring gear, which is engaged with a hypoid pinion gear driven by an internal combustion engine. Alternatively, the input gear 126 may be a helical ring gear, which is engaged with a helical pinion driven by an electric machine. In some implementations, the input gear 126 may be omitted and the differential case 118 may be driven by an output shaft of an electric machine directly. Alternative implementations are contemplated.

As mentioned above, the differential assembly 116 facilitates the left and right wheels 104, 108 rotating at different speeds as the vehicle turns. For example, as the vehicle turns left, the left wheel 104 takes a shorter path than the right wheel 108 and therefore rotates at a slower speed. Performance characteristics can be enhanced by improving the vehicle dynamics, such as how quickly the vehicle can maneuver through a turn. One way of improving the vehicle dynamics is increasing the yaw rate of the vehicle, i.e., how quickly the vehicle can turn without losing traction. One method of increasing the yaw rate is to over-drive the wheel that is rotating faster when the vehicle is turning (i.e., the outside wheel). Said differently, the wheel on the opposite side of the vehicle as the turning direction is over-driven (e.g., if the vehicle is turning left, the right side wheel). Over driving the outside wheel may be effected by increasing the amount of torque supplied to the wheel according to which direction the vehicle is turning, known as torque vectoring.

To this end, the drive module 100 may further comprise a torque vectoring device 128. The torque vectoring device 128 is operable to bias torque between the first output shaft 110 and the second output shaft 112. The torque vectoring device 128 illustrated herein is an electronic torque vectoring device, which is actuated electronically. To this end, the torque vectoring device 128 may comprise an electric actuator 130 coupled to the drive housing 114. The electric actuator 130 may comprise an actuator shaft 132 and an actuator pinion 134 coupled to the actuator shaft 132. The electric actuator 130 is operable to bias torque between the first output shaft 110 and the second output shaft 112. Here, the electric actuator 130 is an electric motor that is operable to rotate the actuator shaft 132 and the actuator pinion 134. More specifically, the electric actuator 130 converts electrical energy into mechanical energy in the form of torque and rotational speed on the actuator shaft 132. As will be discussed in further detail below, the electric actuator 130 is operable in a first mode to provide torque to the actuator shaft 132, which may be referred to as a motoring mode. The electric actuator 130 is further operable in a second mode to absorb torque from the actuator shaft 132, which may be referred to as an absorbing mode.

The torque vectoring device 128 may further comprise a planetary gearset 136 operatively arranged between the electric actuator 130 and the differential assembly 116. The planetary gearset 136 comprises a ring gear 138, a sun gear 140, a planet carrier 142, and at least one planet gear 144. Here, the ring gear 138 is rotationally coupled to the differential case 118. The sun gear 140 is operatively couplable to the electric actuator 130. The planet carrier 142 is rotationally coupled to the first output shaft 110. The planet gear 144 is rotationally supported by the planet carrier 142 and engaged with the ring gear 138 and the sun gear 140. Torque supplied to the sun gear 140 by the electric actuator 130, alters the amount of torque drawn from the differential case 118 by the ring gear 138, and consequently alters the torque supplied by the planet carrier 142 to the left output shaft 110. This torque combines with the torque from the left side gear 120 and is transferred to the left output 102. There is a corresponding alteration in torque on the right output shaft 112. Conversely, torque absorbed by the electric actuator 130 from the sun gear 140, alters the amount of torque provided to the differential case 118 by the ring gear 138, and consequently alters the torque drawn by the planet carrier 142 from the left output shaft 110. This torque is removed from the left output shaft 110 before it reaches the left output 102. There is a corresponding alteration in torque on the right output shaft 112. In other words, the torque vectoring device 128 adjusts an effective gear ratio between the differential case 118 and the left output shaft 110 to over-drive one of the wheels 104, 108.

The torque vectoring device 128 may further comprise a disconnect synchronizer 146 rotationally coupled to the sun gear 140 and the electric actuator 130. The disconnect synchronizer 146 is arranged concentrically with the left output shaft 110 and rotates independently. Said differently, the left output shaft 110 extends through the disconnect synchronizer 146 and each are capable of independently rotating in different directions and at different rates. The disconnect synchronizer 146 is operable in a locked mode for transferring torque between the electric actuator 130 and the sun gear 140 and an unlocked mode in which torque is not transferred between the electric actuator 130 and the sun gear 140. In one implementation, the disconnect synchronizer 146 may be implemented as a plate clutch disconnect, which utilizes one or more rotating friction plates (not shown) to selectively transfer torque between the electric actuator 130 and the sun gear 140. Alternatively, the disconnect synchronizer 146 may be implemented as a dog clutch, a cone clutch, or a sliding disconnect ring. Other implementations are contemplated. Actuation of the disconnect synchronizer 146 between the locked mode and the unlocked mode may be accomplished by an electronic actuator, a hydraulic actuator, an electromagnetic actuator, a pneumatic actuator, or a mechanical actuator.

With continued reference to FIG. 1, the torque vectoring device 128 may further comprise a first hollow shaft 148 and a second hollow shaft 150 with the disconnect synchronizer 146 operably coupled therebetween. Said differently, the disconnect synchronizer 146 is operably coupled between the first hollow shaft 148 and the second hollow shaft 150. The first hollow shaft 148 and the second hollow shaft 150 are arranged in the drive housing 114 concentric with the left output shaft 110. The left output shaft 110 extends through the first hollow shaft 148 and the second hollow shaft 150 and is capable of rotating independently therefrom. More specifically, each of the first hollow shaft 148, the second hollow shaft 150, and the left output shaft 110 are capable of independently rotating in different directions and at different rates. To this end, the first hollow shaft 148 and the second hollow shaft 150 may be rotationally coupled by the disconnect synchronizer 146. When the disconnect synchronizer 146 is in the locked mode, the first hollow shaft 148 and the second hollow shaft 150 are rotationally coupled to transfer torque between the electric actuator 130 and the sun gear 140. When the disconnect synchronizer 146 is in the unlocked mode, the first hollow shaft 148 and the second hollow shaft 150 are rotationally decoupled such that torque is not transferred between the electric actuator 130 and the sun gear 140.

Some implementations of the torque vectoring device 128 may further comprise a layshaft 152 rotationally supported in the drive housing 114 and operatively arranged between the electric actuator 130 and the disconnect synchronizer 146. A first lay gear 154 and a second lay gear 156 may be coupled to the layshaft 152. The layshaft 152 and the first and second lay gears 154, 156 further facilitate torque transfer between the electric actuator 130 and the sun gear 140. Here, the first lay gear 154 engages the electric actuator 130, and more specifically is engaged with the actuator pinion 134 coupled to the actuator shaft 132. The second lay gear 156 engages the disconnect synchronizer 146, and more specifically is engaged with a third lay gear 158, which is coupled to the disconnect synchronizer 146 and the first hollow shaft 148. The layshaft 152 and the lay gears 154, 156, 158 alter the rotational rate and torque of the electric actuator 130 and the sun gear 140, to achieve the desired rotational rate and torque characteristics. Here, the rotation rate of the electric actuator 130 is reduced in two stages, a first stage of engagement between the actuator pinion 134 and the first lay gear 154 and a second stage of engagement between the second lay gear 156 and the third lay gear 158.

As mentioned above, the electric actuator 130 is operable in a first mode and a second mode. In the first mode, the electric actuator 130 provides torque to the actuator shaft 132. In the second mode, the electric actuator 130 absorbs torque from the actuator shaft 132. Said differently, operating the electric actuator 130 to provide torque to the actuator shaft 132 in the first mode biases torque applied to the differential case 118 toward the left output shaft 110. Conversely, operating the electric actuator 130 to absorb torque from the actuator shaft 132 in the second mode biases torque applied to the differential case 118 toward the right output shaft 112.

When the vehicle is turning, the wheel on the outside of the turn rotates faster than the differential case 118 while the wheel on the inside of the turn rotates slower than the differential case 118. Furthermore, the faster rotating outside wheel has proportionally less torque than the slower rotating inside wheel. In the first mode, torque flows from the electric actuator 130 to the sun gear 140 and the planet carrier 142, which applies a torque to the left output shaft 110 in the same direction the left output shaft 110 is rotating, thereby increasing torque on the left wheel 104. Conversely, in the second mode, torque flows from the sun gear 140 to the electric actuator 130, which provide a rotating reaction force to apply torque from the differential case 118 to the right output shaft 112, thereby increasing torque on the right wheel 108.

When the vehicle is operating in a straight path (i.e., not turning), the left wheel 104 and the right wheel 108 rotate at the same rate as the input gear 126 and the differential case 118. As such, the planet carrier 142 and the ring gear 138 also rotate at the same rate. Because the vehicle is operating in a straight path there is an equal torque on the left and right wheels 104, 108 and no yaw force on the vehicle. In this operating condition, the disconnect synchronizer 146 is operated in the unlocked mode to decouple the electric actuator 130 from the sun gear 140. By disconnecting the electric actuator 130 from the sun gear 140, the actuator shaft 132 and the layshaft 152 will remain stationary, thereby reducing losses associated with increased rotating mass. Furthermore, the planet gear 144 does not rotate when the planet carrier 142 and the ring gear 138 are rotating at the same rate, further reducing losses associated with friction.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

What is claimed is:

1. A torque vectoring device for a vehicle drive module, the torque vectoring device comprising:
an electric actuator; and
a planetary gearset comprising:
a ring gear rotationally coupled to a differential case;
a sun gear operatively couplable to the electric actuator;
a planet carrier rotationally coupled to a first output shaft; and
a planet gear rotationally supported by the planet carrier and engaged with the ring gear and the sun gear;
wherein the electric actuator is operable to bias torque between the first output shaft and a second output shaft.

2. The torque vectoring device of claim 1, further comprising a disconnect synchronizer rotationally coupled to the sun gear and the electric actuator, wherein the disconnect synchronizer is operable in a locked mode for transferring torque between the electric actuator and the sun gear and an unlocked mode in which torque is not transferred between the electric actuator and the sun gear.

3. The torque vectoring device of claim 2, further comprising a layshaft operatively arranged between the electric actuator and the disconnect synchronizer.

4. The torque vectoring device of claim 3, further comprising a first lay gear coupled to the layshaft and a second lay gear coupled to the layshaft, wherein the first lay gear engages the electric actuator, and the second lay gear engages the disconnect synchronizer.

5. The torque vectoring device of claim 2, further comprising a first hollow shaft and a second hollow shaft, wherein the disconnect synchronizer is operably coupled between the first hollow shaft and the second hollow shaft, and wherein the first hollow shaft and the second hollow shaft are rotationally coupled when the disconnect synchronizer is in the locked mode, and wherein the first hollow shaft and the second hollow shaft are rotationally decoupled when the disconnect synchronizer is in the unlocked mode.

6. The torque vectoring device of claim 5, wherein the first hollow shaft and the second hollow shaft are concentric with the first output shaft.

7. The torque vectoring device of claim 2, wherein the disconnect synchronizer is concentric with the first output shaft.

8. The torque vectoring device of claim 1, further comprising a layshaft operatively arranged between the electric actuator and the sun gear.

9. The torque vectoring device of claim 1, wherein the electric actuator comprises an actuator shaft, and wherein operating the electric actuator to rotate the actuator shaft biases torque toward the first output shaft, and wherein operating the electric actuator to brake the actuator shaft biases torque toward the second output shaft.

10. A drive module for a vehicle, the drive module comprising:
a first output shaft;
a second output shaft;
a differential assembly; and
a torque vectoring device comprising:
an electric actuator;
a ring gear rotationally coupled to the differential assembly;
a sun gear operatively couplable to the electric actuator;
a planet carrier rotationally coupled to the first output shaft; and
a planet gear rotationally supported by the planet carrier and engaged with the ring gear and the sun gear;
wherein the electric actuator is operable to bias torque between the first output shaft and the second output shaft.

11. The drive module of claim 10, wherein the torque vectoring device further comprises a disconnect synchronizer rotationally coupled to the sun gear and the electric actuator, wherein the disconnect synchronizer is operable in a locked mode for transferring torque between the electric actuator and the sun gear and an unlocked mode in which torque is not transferred between the electric actuator and the sun gear.

12. The drive module of claim 11, wherein the torque vectoring device further comprises a first hollow shaft and a second hollow shaft, wherein the disconnect synchronizer is operably coupled between the first hollow shaft and the second hollow shaft, and wherein the first hollow shaft and the second hollow shaft are rotationally coupled when the disconnect synchronizer is in the locked mode, and wherein the first hollow shaft and the second hollow shaft are rotationally decoupled when the disconnect synchronizer is in the unlocked mode.

13. The drive module of claim 10, wherein the differential assembly comprises a differential case, a first side gear coupled to the first output shaft, and a second side gear coupled to the second output shaft, and wherein the differential case is coupled to the ring gear.

14. The drive module of claim 13, further comprising an input gear coupled to the differential case.

15. The drive module of claim 10, further comprising a drive housing, wherein the differential assembly is rotatably supported in the drive housing, and wherein the electric actuator is coupled to the drive housing.

16. The drive module of claim 10, wherein the electric actuator comprises an actuator shaft, and wherein operating the electric actuator to apply torque to the actuator shaft biases torque toward the first output shaft, and wherein operating the electric actuator to absorb torque from the actuator shaft biases torque toward the second output shaft.
